(19) United States
(12) Patent Application Publication
(10) Pub. No.: US 2018/0173396 A1
(43) Pub. Date: Jun. 21, 2018

(54) VISUAL REMOTE CONTROL METHOD AND SYSTEM FOR TOUCH-CONTROLLABLE DEVICE, AND RELATED DEVICE

(71) Applicant: HUAWEI TECHNOLOGIES CO., LTD., Shenzhen (CN)

(72) Inventors: Yimin LIN, Shenzhen (CN); Shiguo LIAN, Shenzhen (CN)

(73) Assignee: HUAWEI TECHNOLOGIES CO., LTD., Shenzhen (CN)

(21) Appl. No.: 15/898,838

(22) Filed: Feb. 19, 2018

Related U.S. Application Data
(63) Continuation of application No. PCT/CN2016/092694, filed on Aug. 1, 2016.

(30) Foreign Application Priority Data
Aug. 18, 2015 (CN) 201510508032.7

(51) Int. Cl. G06F 3/0488; H04L 12/28; G06F 17/30

(52) U.S. Cl. CPC G06F 3/0488; G06F 17/30017; H04L 12/2816

(57) ABSTRACT

Examples of the present disclosure provide a visual remote control method and system for controlling a touch-controllable device. The method includes: obtaining, by a control center device, a video image; determining, by the control center device, an identifier of each of at least one touch-controllable device in the video image; and sending, by the control center device, the video image and the identifier of each touch-controllable device to a remote device, so that the touch-controllable device in the video image is controllable by using the remote device.

### CROSS-REFERENCE TO RELATED APPLICATIONS

This application is a continuation of International Application No. PCT/CN2016/092694, filed on Aug. 1, 2016, which claims priority to Chinese Patent Application No. 201510508032.7 filed on Aug. 18, 2015. The disclosures of the aforementioned applications are hereby incorporated by reference in their entireties.

### TECHNICAL FIELD

Examples of the present disclosure relate to the field of information technologies, and more specifically, to a visual remote control method and system for a touch-controllable device.

### BACKGROUND

Development of an Internet of Things (IoT for short) technology has resulted in an increasing quantity of touch-controllable devices that can be remotely controlled. An existing technical solution for remotely controlling a touch-controllable device requires that a user select an identification (ID) of a to-be-controlled touch-controllable device from a device list. If there are many types and a large quantity of controllable touch-controllable devices, it is quite difficult to search for corresponding hardware. Also, a remote device, for example, a mobile phone, a tablet computer, or a computer, configured to remotely control a touch-controllable device can discover a working status of the touch-controllable device only by using a graphical interface.

### SUMMARY

The present disclosure provides a method, a system and a device for controlling ouch-controllable device.

According to a first aspect, a visual remote control method for controlling a touch-controllable device is provided. The method may be executed by a control center device in a remote control system. The method may include obtaining, by the control center device, a video image; determining, by the control center device, an identifier of each of at least one touch-controllable device in the video image; and sending, by the control center device, the video image and the identifier of each touch-controllable device to a remote device, so that the touch-controllable device in the video image is controllable by using the remote device.

According to a second aspect, a visual remote control system for controlling a touch-controllable device is provided. The system may include a control center device, a remote device, and N touch-controllable devices, where N is a positive integer that is greater than or equal to 1; the control center device may be configured to obtain a video image; the control center device may be configured to determine an identifier of each touch-controllable device that is in the video image and each touch-controllable device is in the N touch-controllable devices; the control center device may be configured to send the video image and the identifier of each touch-controllable device to the remote device; the remote device may be configured to receive the video image and the identifier of each touch-controllable device that are sent by the control center device; and the remote device may be configured to present the video image and the identifier of each touch-controllable device on a display interface.

According to a third aspect, a network device for controlling a touch-controllable device is provided. The network device may include an obtaining circuit, configured to obtain a video image; a determining circuit, configured to determine an identifier of each of at least one touch-controllable device in the video image; and a sending circuit, configured to send the video image and the identifier of each touch-controllable device to a remote device, so that the touch-controllable device in the video image is controllable by using the remote device.

It is to be understood that both the forgoing general description and the following detailed description are exemplary only, and are not restrictive of the present disclosure.

### BRIEF DESCRIPTION OF DRAWINGS

To describe the technical solutions in the examples of the present disclosure more clearly, the following briefly describes the accompanying drawings required for describing the examples of the present disclosure. Apparently, the accompanying drawings in the following description show merely some examples of the present disclosure, and a person of ordinary skill in the art may still derive other drawings from these accompanying drawings without creative efforts.

FIG. 1 is a schematic flowchart of a visual remote control method for a touch-controllable device according to an example of the present disclosure;

FIG. 2 is a schematic diagram of a visual remote control system for a touch-controllable device according to an example of the present disclosure;

FIG. 3 is a schematic diagram of another visual remote control system for a touch-controllable device according to an example of the present disclosure;

FIG. 4 is a schematic diagram of attribute information of two touch-controllable devices;

FIG. 5 is a schematic flowchart of a feature extraction method based on a two-dimensional image;

FIG. 6 is a schematic diagram of a shooting angle V;

FIG. 7 is a schematic flowchart of a feature extraction method based on a three-dimensional depth image;

FIG. 8 is a schematic flowchart of feature identification performed by using a two-dimensional image;

FIG. 9 is a schematic flowchart of feature identification performed by using a three-dimensional depth image;

FIG. 10 is a schematic diagram of displaying a video image and a touch-controllable device on a display interface of a remote device;

FIG. 11 is a schematic diagram of displaying a video image, a selected touch-controllable device, and a UI of the selected touch-controllable device on a display interface of a remote device;

FIG. 12 is another schematic diagram of displaying a video image, a selected touch-controllable device, and a UI of the selected touch-controllable device on a display interface of a remote device;

FIG. 13 is a structural block diagram of a network device according to an example of the present disclosure; and

FIG. 14 is a structural block diagram of a device for controlling a touch-controllable device according to an example of the present disclosure.

### DETAILED DESCRIPTION

The following clearly describes the technical solutions in the examples of the present disclosure with reference to the accompanying drawings in the examples of the present disclosure. Apparently, the described examples are a part rather than all of the examples of the present disclosure. All other examples obtained by a person of ordinary skill in the art based on the examples of the present disclosure without creative efforts shall fall within the protection scope of the present disclosure.

A touch-controllable device in the examples of the present disclosure has at least one adjustable running parameter. A user may adjust the at least one adjustable running parameter by using an application (APP for short). For example, the touch-controllable device may be a desk lamp. An adjustable running parameter of the desk lamp may be “on” and “off”. Alternatively, the adjustable running parameter of the desk lamp may further include brightness of the lamp. For another example, the touch-controllable device may alternatively be a television. An adjustable running parameter of the television may include on/off, volume, channels, and the like.

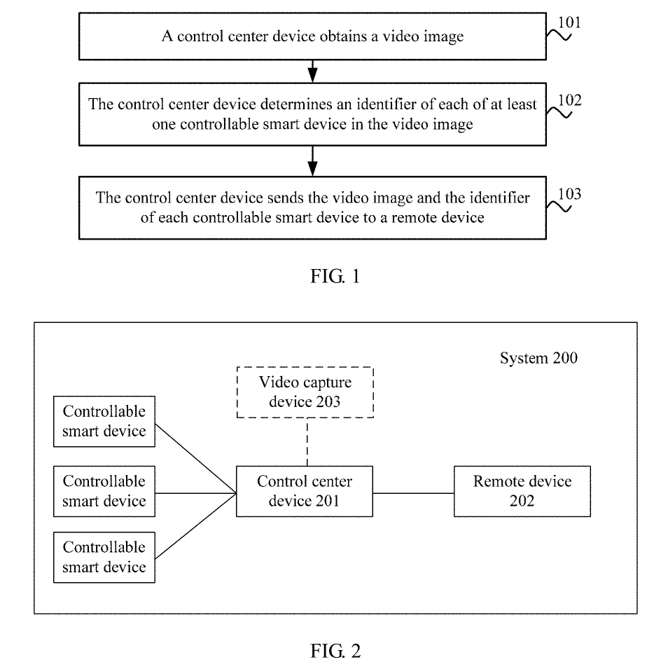

FIG. 1 is a schematic flowchart of a visual remote control method for a touch-controllable device according to an example of the present disclosure. The method shown in FIG. 1 is executed by a control center device in a remote control system.

101: The control center device obtains a video image.

102: The control center device determines an identifier of each of at least one touch-controllable device in the video image.

103: The control center device sends the video image and the identifier of each touch-controllable device to a remote device, so that a user can control the touch-controllable device in the video image by using the remote device.

According to the method shown in FIG. 1, the control center device in the remote control system can obtain the video image, identify the touch-controllable device in the video image, and send the video image and the identifier of the identified touch-controllable device to the remote device. In this way, the user can view, in real time, the video image by using the remote device, and can conveniently determine, from the video image according to the identifier of the touch-controllable device, a touch-controllable device that can be remotely controlled, and further select a touch-controllable device that needs to be controlled. When the user needs to adjust an adjustable running parameter of the touch-controllable device, the user can view an actual running parameter of the controlled touch-controllable device instead of simulated a running parameter by using a graphical interface, of the touch controllable device.

Optionally, in an example, the determining, by the control center device, an identifier of each of at least one touch-controllable device in the video image includes: performing, by the control center device, local-feature extraction on the video image; matching an extracted local feature with a visual feature of a touch-controllable device stored in a hardware database, to determine whether a visual feature, matching the local feature, of a touch-controllable device exists in the hardware database; and if the visual feature, matching the local feature, of the touch-controllable device exists in the hardware database, determining an identifier of the touch-controllable device that is included in the video image and that is corresponding to the matched visual feature. The hardware database includes attribute information of N touch-controllable devices, where the attribute information includes identifiers of the touch-controllable devices, visual features of the touch-controllable devices, application programming interfaces (API for short) of the touch-controllable devices, and control user interfaces (UI for short) of the touch-controllable devices.

Further, before the control center device determines the identifier of each of the at least one touch-controllable device in the video image, the control center device may further obtain the attribute information of the N touch-controllable devices. The control center may store the attribute information of the N touch-controllable devices in the hardware database.

The obtaining, by the control center device, the attribute information of the N touch-controllable devices includes: receiving, by the control center device, attribute information sent by each of the N touch-controllable devices; or receiving, by the control center device, an identifier sent by each of the N touch-controllable devices, and obtaining, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

Optionally, in another example, the determining, by the control center device, an identifier of each of at least one touch-controllable device in the video image includes: receiving, by the control center device, the identifier of each touch-controllable device sent by a video capture device.

Further, the method may further include: receiving, by the control center device, first adjustment information sent by the remote device, where the first adjustment information is used to adjust an adjustable running parameter of a first touch-controllable device, and the at least one touch-controllable device includes the first touch-controllable device; and sending, by the control center device, the first adjustment information to the first touch-controllable device, so that the first touch-controllable device adjusts the adjustable running parameter according to the first adjustment information.

Further, the method may further include: determining, by the control center device, coordinates of the first touch-controllable device, and sending the coordinates of the first touch-controllable device to the remote device.

FIG. 2 is a schematic diagram of a visual remote control system for a touch-controllable device according to an example of the present disclosure. As shown in FIG. 2, the system 200 includes a control center device 201, a remote device 202, and N touch-controllable devices, where N is a positive integer greater than or equal to 1.

The control center device 201 is configured to obtain a video image.

The control center device 201 is further configured to determine an identifier of each touch-controllable device that is in the video image and that is in the N touch-controllable devices.

The control center device 201 is further configured to send the video image and the identifier of each touch-controllable device to the remote device 202.

The remote device 202 is configured to receive the video image and the identifier of each touch-controllable device that are sent by the control center device 201.

The remote device 202 is further configured to present the video image and the identifier of each touch-controllable device on a display interface.

According to the system shown in FIG. 2, the control center device can identify the touch-controllable device in the video image, and send the identifier of the touch-controllable device to the remote device. In this way, a user can conveniently determine, according to the identifier of the touch-controllable device and from the video image presented on the display interface of the remote device, a touch-controllable device that can be remotely controlled, and further select a touch-controllable device that needs to be controlled.

The control center device 201 is specifically configured to: perform local-feature extraction on the video image; match an extracted local feature with a visual feature of a touch-controllable device stored in a hardware database, to determine whether a visual feature, matching the local feature, of a touch-controllable device exists in the hardware database; and if the visual feature, matching the local feature, of the touch-controllable device exists in the hardware database, determine an identifier of the touch-controllable device that is included in the video image and that is corresponding to the matched visual feature. The hardware database includes attribute information of the N touch-controllable devices, where the attribute information includes identifiers of the touch-controllable devices, visual features of the touch-controllable devices, APIs of the touch-controllable devices, and control UIs of the touch-controllable devices. Optionally, the hardware database may be integrated into the control center device 201, may be an independent device, or may be integrated into another device.

The control center device 201 is further configured to obtain the attribute information of the N touch-controllable devices, and store the attribute information of the N touch-controllable devices in the hardware database.

Optionally, the control center device 201 is specifically configured to receive attribute information sent by each of the N touch-controllable devices; or the control center device 201 is specifically configured to receive an identifier sent by each of the N touch-controllable devices, and obtain, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

Optionally, in an example, the system 200 may further include a video capture device 203. The video capture device 203 is configured to obtain the video image, and determine the identifier of each touch-controllable device in the video image. The video capture device 203 may be further configured to send the video image and the identifier of each touch-controllable device to the control center device 201. The control center device 201 is specifically configured to receive the video image and the identifier of each touch-controllable device that are sent by the video capture device.

Further, the remote device 202 is further configured to obtain first input. The first input is used to select a first touch-controllable device, and the first controllable smart device is a touch-controllable device in the video image. The remote device 202 is further configured to obtain a control UI of the first touch-controllable device and an API of the first touch-controllable device. The remote device 202 is further configured to display the control UI of the first touch-controllable device on the display interface. Optionally, the remote device 202 may directly obtain the control UI of the first touch-controllable device and the API of the first touch-controllable device from the hardware database. The remote device 202 may alternatively obtain the control UI of the first touch-controllable device and the API of the first touch-controllable device by using the control center device 201.

Further, the remote device 202 is further configured to obtain second input that is used to adjust an adjustable running parameter of the first touch-controllable device, and send a first adjustment information to the control center device 201, where the first adjustment information is used to adjust the adjustable running parameter of the first touch-controllable device. The control center device is further configured to send the received first adjustment information to the first controllable device. The first controllable device is configured to adjust the corresponding adjustable running parameter according to the first adjustment information.

T+he following describes the technical solutions of the present disclosure with reference to specific examples. It can be understood that the specific examples are merely intended to facilitate better understanding of the present disclosure, but not to limit the present disclosure.

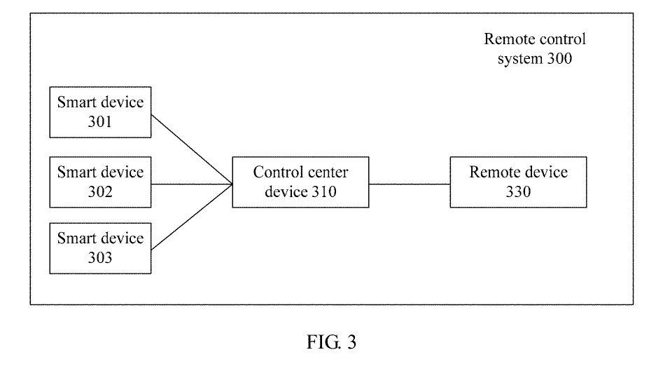

FIG. 3 is a schematic diagram of another visual remote control system for a touch-controllable device according to an example of the present disclosure. As shown in FIG. 3, the remote control system 300 includes three touch-controllable devices: a touch-controllable device 301, a touch-controllable device 302, and a touch-controllable device 303. The remote control system 300 further includes a control center device 310 and a remote device 330.

When joining into the remote control system 300, the touch-controllable device 301, the touch-controllable device 302, and the touch-controllable device 303 send registration information to the control center device 310 to accomplish a registration process. The registration information may include attribute information of the touch-controllable devices, and the attribute information includes identifiers of the touch-controllable devices, visual features of the touch-controllable devices, APIs of the touch-controllable devices, and control UIs of the touch-controllable devices.

Alternatively, the registration information may include only identifiers of the touch-controllable devices. The control center device 310 receives registration information sent by each of the touch-controllable devices. When the registration information includes the attribute information of the touch-controllable devices, the control center device 310 may store, in a hardware feature database, the attribute information of the touch-controllable devices in the registration information. The hardware feature database may be located in the control center device 310, may be independent hardware, or may be integrated into other hardware (for example, a server). This is not limited in the present disclosure. When the registration information includes only the identifiers of the touch-controllable devices, the control center device 310 may obtain, according to the identifiers of the touch-controllable devices, the visual features, APIs, and control UIs of the corresponding touch-controllable devices from a server that stores the attribute information of the touch-controllable devices. The control center device 310 may store the obtained visual features, APIs, and control UIs in the hardware feature database.

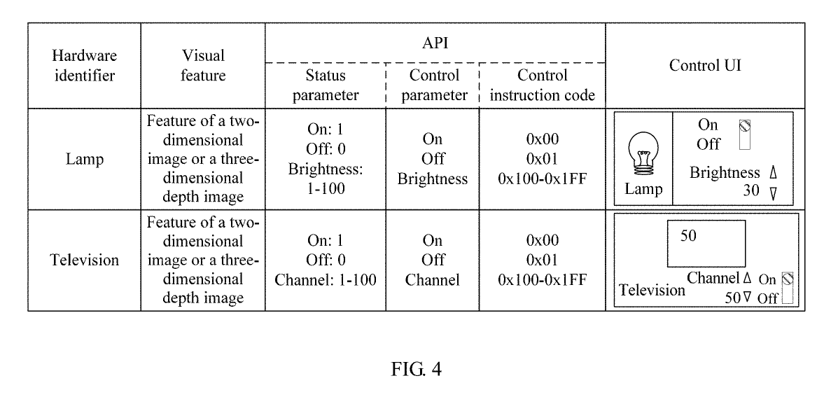

FIG. 4 is a schematic diagram of attribute information of two touch-controllable devices.

Optionally, in addition to the identifiers, visual features, APIs, and control UIs of the touch-controllable devices, the attribute information may include another element, for example, a supported communications protocol, a supported power supply standard, or the like.

The visual features prestored in the touch-controllable devices or the server are measured in advance. The visual feature model library May be a feature of a two-dimensional image, or may be a feature of a three-dimensional depth image. A person skilled in the art can understand that, because a touch-controllable device may be placed in multiple manners and an apparatus for controlling a touch-controllable device may obtain an image of the touch-controllable device from multiple angles, visual features, obtained when different shooting angles are used, of the touch-controllable device may be measured in advance.

The following separately describes two feature creation methods.

FIG. 5 is a schematic flowchart of a feature extraction method based on a two-dimensional image.

501: Input a quantity K of viewing angles.

The quantity K of viewing angles V from which a camera shoots a touch-controllable device is set. The viewing angle V indicates a relationship between an optical axis z_{c} of the camera and a coordinate system of the touch-controllable device. A specific relationship is shown by the following formula:

V=[θ,β,r] (Formula 1.1)

where θ∈[0,180°], β∈[0,360° ], and r is a distance between the camera and an origin of the coordinate system of the touch-controllable device.

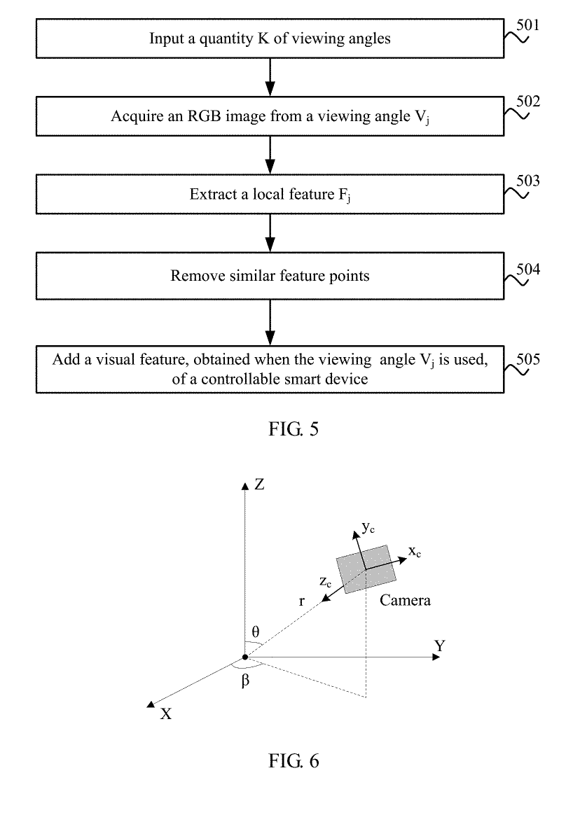

FIG. 6 is a schematic diagram of a shooting angle V, where X, Y, and Z and x_{c}, y_{c}, and z_{c} are coordinate systems of a touch-controllable device and a camera respectively, θ∈[0,180°], β∈[0,360°], and r is a distance between the camera and an origin of the coordinate system of the touch-controllable device.

Therefore, the quantity K of viewing angles and the shooting angle V are preset according to a texture feature and shape complexity of the touch-controllable device, so as to comprehensively record a visual feature set, obtained when different viewing angles are used, of the touch-controllable device.

502: Acquire an RGB image from a viewing angle Vⱼ, that is, acquire the RGB image of the touch-controllable device from the viewing angle Vⱼ by using an RGB camera, where j∈[1,K].

503: Extract a local feature F_{J}, that is, extract, from the RGB image, the visual feature Fⱼ with rotation and scale invariance, where Fⱼ may be represented as the following n-dimensional vector:

Fⱼ=[a₁,a₂, . . . ,aₙ] (Formula 1.2)

where aᵢ is a real number, and n usually has different values when different local-feature extraction methods are used. Common feature extraction methods include scale-invariant feature transform (SIFT for short), speeded-up robust feature (SURF for short), “oriented FAST (Features from Accelerated Segment Test) and rotated BRIEF (Binary Robust Independent Elementary Features) (Oriented Fast and Rotated BRIEF, or ORB for short), and fast retina keypoint (Fast Retina Keypoint, or FREAK for short)”, and the like. When feature extraction is performed by using SIFT, a value of n is 128. When feature extraction is performed by using SURF, a value of n is 64. When feature extraction is performed by using ORB, a value of n is 32. When feature extraction is performed by using FREAK, a value of n is 64.

504: Remove similar feature points, that is, remove a feature point pair with relatively high similarity from a feature point set according to a distance measurement function (for example, a Euclidean distance, a Hamming distance, or a Mahalanobis distance) of a feature descriptor F, to ensure feature descriptor uniqueness.

505: Add a visual feature, obtained when the viewing angle Vⱼ is used, of the touch-controllable device, that is, store the local-feature descriptor F and the viewing angle V in a visual feature model library Model library M(Vⱼ, Fⱼ).

After the visual feature obtained when the viewing angle Vⱼ is used is determined, a visual feature obtained when another viewing angle is used may be determined. A process of determining the visual feature obtained when the other viewing angle is used is the same as a process of determining the visual feature obtained when the viewing angle Vⱼ is used. That is, visual features obtained when all viewing angles are used may be determined and then stored in the visual feature model library M by repeating step 502 to step 505. In this case, the visual feature model library M stores local-feature descriptors F and corresponding viewing angle parameters V obtained when different viewing angles are used. The visual feature model library May be stored in the corresponding touch-controllable device or may be stored in a server. It can be understood that, when the visual feature is stored in the server, an identifier of smart hardware corresponding to the visual feature also needs to be stored. When the touch-controllable device is added to a remote control system, if the touch-controllable device does not store the visual feature, the touch-controllable device may send an identifier of the touch-controllable device to a control center device. The control center device may obtain, according to the identifier of the touch-controllable device, the visual feature of the touch-controllable device from the server that stores the visual feature. If the touch-controllable device stores the visual feature, the touch-controllable device may simultaneously send the stored visual feature and the identifier to the control center device, so that the control center device can determine, from a video image by using the visual feature, whether the touch-controllable device is stored.

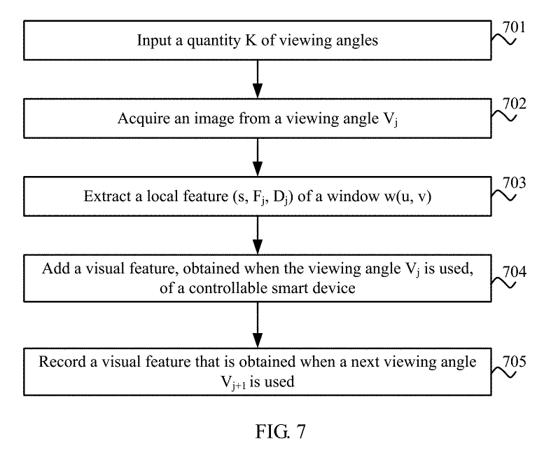

FIG. 7 is a schematic flowchart of a feature extraction method based on a three-dimensional depth image.

701: Input a quantity K of viewing angles.

The quantity K of viewing angles V from which a camera shoots a touch-controllable device is set according to a texture feature and shape complexity of the touch-controllable device, so as to comprehensively record a visual feature set, obtained when different viewing angles are used, of the touch-controllable device. A meaning of the viewing angle V is the same as a meaning of a viewing angle V used during feature extraction performed by using a two-dimensional image, and details do not need to be described herein.

702: Acquire an image from a viewing angle Vⱼ, that is, acquire an RGB image and a depth image of a touch-controllable device from the viewing angle Vⱼ by using an RGBD camera, where j∈[1,K].

703: Extract a local feature (s, Fⱼ, Dⱼ) of a window w(u, v).

Specifically, a point whose coordinates are (u, v) is randomly selected from the RGB image. A length and a width of the feature extraction window w(u, v) are both s×L, where L is a size of an initial feature extraction window, s is a scale of a current feature extraction window, and s is represented by using the following formula:

$$s = \frac{D}{d} \qquad ( Formula 1.3 )$$

where d is a depth value corresponding to the depth image coordinates (u, v) at which a current feature point is located, and D is an initial depth constant. For example, L=31 pixels and D=550 mm may be set according to an actual status of internal and external parameters of a sensor of the RGBD camera that obtains the depth image.

The local feature Fⱼ(u, v) with rotation and scale invariance is extracted from the window w whose image coordinates are (u, v). Common feature extraction methods include SIFT, SURF, ORB, FREAK, and the like. In addition, the depth value d(u, v) is mapped to a three-dimensional coordinate value Dⱼ(x, y, z) according to the intrinsic internal and external parameters of the sensor of the RGBD camera.

704: Add a visual feature, obtained when the viewing angle Vⱼ is used, of the touch-controllable device, that is, store the three-dimensional coordinates Dⱼ(x, y, z) and the previously extracted feature Fⱼ and scale s all in a visual feature model library Model library M(s, Fⱼ, Dⱼ) of the touch-controllable device.

705: Record a visual feature that is obtained when a next viewing angle Vⱼ₊₁ is used. The shooting angle Vⱼ₊₁ of the RGBD camera is changed, a transformation relation H(V_{J}, Vⱼ₊₁) between coordinate systems of the two viewing angles Vⱼ and Vⱼ₊₁ is calculated according to an existing three-dimensional data splicing method such as ICP and SLAM, and image data previously acquired by the RGBD camera is collectively transformed to data that is obtained when the first viewing angle V₀ is used. This is specifically shown by the following formula:

$${I}_{j + 1}^{*} ( RGB , Depth ) = [ {\prod }_{j = 0}^{K} H ( {V}_{j} , {V}_{j + 1} ) ] {I}_{j + 1} ( RGB , Depth ) \qquad ( Formula 1.4 )$$

where I(RGB, Depth) represents RGB and depth image data acquired by the RGBD camera.

A similarity to a feature extraction method based on a two-dimensional image lies in that, after the visual feature obtained when the viewing angle Vⱼ is used is determined, a visual feature obtained when another viewing angle is used may be determined. A process of determining the visual feature obtained when the another viewing angle is used is the same as a process of determining the visual feature obtained when the viewing angle Vⱼ is used. That is, visual features obtained when all viewing angles are used may be determined and then stored in the visual feature model library M by repeating step 702 to step 705. In this case, the visual feature model library M stores local-feature descriptors F and corresponding viewing angle parameters V obtained when different viewing angles are used. The visual feature model library May be stored in the corresponding touch-controllable device or may be stored in a server. It can be understood that, when the visual feature is stored in the server, an identifier of smart hardware corresponding to the visual feature also needs to be stored. When the touch-controllable device is added to a remote control system, if the touch-controllable device does not store the visual feature, the touch-controllable device may send an identifier of the touch-controllable device to a control center device. The control center device may obtain, according to the identifier of the touch-controllable device, the visual feature of the touch-controllable device from the server that stores the visual feature. If the touch-controllable device stores the visual feature, the touch-controllable device may simultaneously send the stored visual feature and the identifier to the control center device, so that the control center device can determine, from a video image by using the visual feature, whether the touch-controllable device is stored.

After a registration process of a touch-controllable device is completed, the control center device 310 may identify the registered touch-controllable device. The control center device 310 may determine, by using an obtained video image, coordinates of the touch-controllable device in the video image and an identifier of the touch-controllable device.

Specifically, a method used by the control center device 310 to identify the touch-controllable device is related to a visual-feature composition method of the touch-controllable device. If a visual feature of the touch-controllable device is generated by using a two-dimensional image, the control center device 310 also identifies the touch-controllable device in a manner of obtaining a local feature of a two-dimensional image. If a visual feature of the touch-controllable device is generated by using a three-dimensional depth image, the control center device 310 also identifies the touch-controllable device in a manner of obtaining a local feature of a three-dimensional depth image. The following describes in detail how the control center device 310 identifies the touch-controllable device.

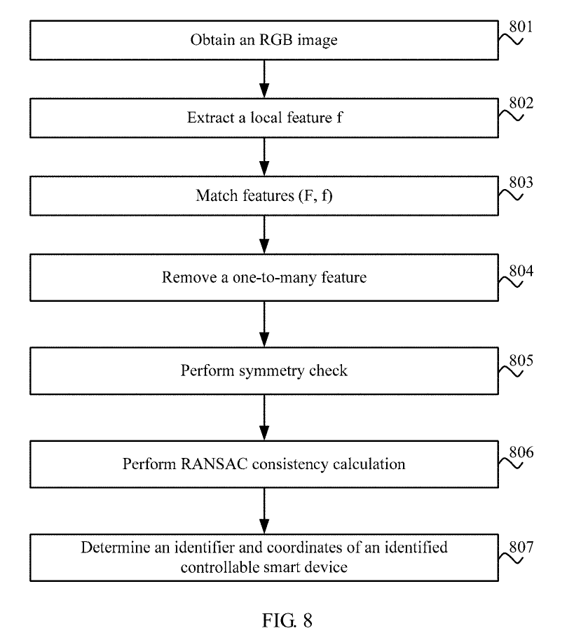

FIG. 8 is a schematic flowchart of feature identification performed by using a two-dimensional image.

801: Obtain an RGB image.

The RGB image is obtained by using a camera. The camera may be integrated into the control center device 310. Alternatively, the camera may be an independent apparatus, and sends the acquired RGB image to the control center device 310. This is not limited in the present disclosure.

802: Extract a local feature f, that is, extract the local feature from the obtained RGB image. Common methods may be SIFT, SURF, ORB, FREAK, and the like.

803: Match features (F, f).

A visual feature model library M_{C}(Fⱼ, Vⱼ) of the C^{th} touch-controllable device is indexed in a hardware feature database, where j∈[1,K]. All feature descriptors Fᵢ are traversed in an Fⱼ set obtained when the Vⱼ^{th} viewing angle is used, where Fᵢ□Fⱼ. An f set is searched for two pairs of optimal match feature points (Fᵢ, fₖ) and (Fᵢ, fⱼ), where a distance (common distance measurement functions include a Euclidean distance, a Hamming distance, a Mahalanobis distance, and the like) between two feature points of each pair of optimal match feature points is shortest. The distances between the feature points of the two pairs of optimal match feature points are d_F2fᵢₖ and d_F2fᵢⱼ respectively, and d_F2fᵢₖ<d_F2fᵢⱼ. Similarly, any one feature descriptor fᵢ is selected from the f set, and two pairs of optimal match feature points are (fᵢ, Fₖ) and (fᵢ, Fₘ), where distances between the feature points of the two pairs of optimal match feature points are d_f2Fᵢₖ and d_f2Fᵢₘ respectively, and d_f2Fᵢₖ<d_f2Fᵢₘ.

804: Remove a one-to-many feature.

The match feature point pairs (Fᵢ, fₖ) and (Fᵢ, fⱼ) stored in the Fⱼ set are traversed. If d_F2fᵢₖ/d_F2fᵢⱼ>th, where th is a one-to-many threshold, for example, th=0.65, it is considered that match confidence of the feature point pairs is relatively low, and the feature point Fᵢ needs to be removed. Otherwise, the Fᵢ is preserved, and a group of updated F* is finally obtained. Similarly, a one-to-many feature is removed from the feature set, and a group of updated f* is also obtained.

805: Perform symmetry check. All feature points in the F* are traversed, and if match points stored in the F* are different from match points stored in the f*, the match point in the f* is removed. Similarly, all feature points in the f* are traversed, and if match points stored in the f* are different from match points stored in the F*, the feature point in the f* is removed. That is, if Fᵢ and Fₘ in (Fᵢ, fₖ) and (fₖ, Fₘ) are not a same point, the mismatched point fₖ is removed.

806: Perform RANSAC consistency calculation.

RANSAC consistency is calculated in remaining F*s and f*s, and a homography matrix H is obtained. Then, a re-projection error of a feature point set is calculated by using the following formula:

$$err = \frac{1}{N} {\sum }_{i = 0}^{N} {‖ {q}_{{F}_{i}^{*}} - H \times {q}_{{f}_{i}^{*}} ‖}_{2} \qquad ( Formula 1.5 )$$

where N is a quantity of feature points in the set F*, q represents image coordinate values of x and y of a feature point, and ∥ ∥₂ represents an operation of obtaining a distance between two points.

807: Determine an identifier and coordinates of an identified touch-controllable device.

If err<T, where T is a re-projection error threshold, for example, T=3 pixels, it indicates that a currently extracted feature point successfully matches a feature F*, obtained when a viewing angle Vⱼ is used, of a target C in a hardware visual feature database. The identifier C of the current touch-controllable device is returned, and the image coordinates at which the target is located is calculated according to the homography matrix H. Otherwise, operations corresponding to a next viewing angle Vⱼ₊₁ and a next target C+1 are to be performed, and step 803 to step 807 are repeated, until all hardware is traversed.

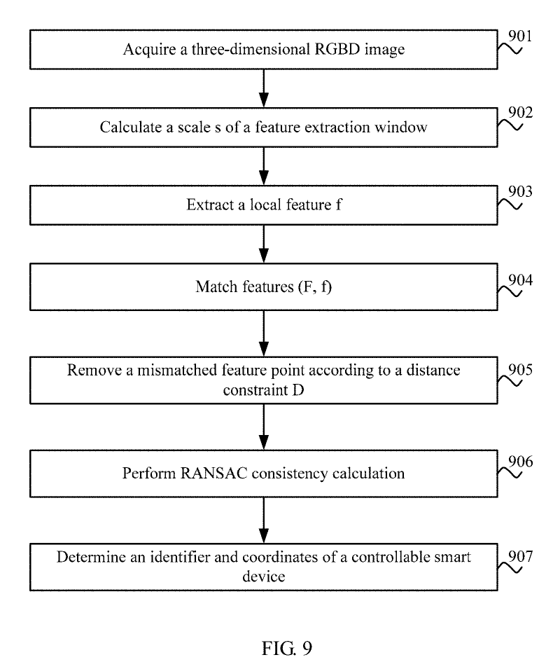

FIG. 9 is a schematic flowchart of feature identification performed by using a three-dimensional depth image.

901: Acquire a three-dimensional RGBD image.

The RGBD image is obtained by using an RGBD camera. The camera may be integrated into the control center device 310. Alternatively, the camera may be an independent apparatus, and sends the acquired RGBD image to the control center device 310. This is not limited in the present disclosure. The RGBD image includes an RGB image and a depth image.

902: Calculate a scale s of a feature extraction window.

A point whose coordinates are (u, v) is selected from the RGB image. It is determined, according to a corresponding depth value d(u, v), that the scale of the feature extraction window w(u, v) is s=d/D.

903: Extract a local feature f.

It is determined, by using the window scale s, that a length and a width of the window are both L×s. The local feature is extracted from the RGB image corresponding to the window. Common methods include SIFT, SURF, ORB, FREAK, and the like.

904: Match features (F, f).

A visual feature (F, D) of the C^{th} hardware is indexed in a hardware visual feature database. All feature descriptors fᵢ are traversed in an f set. An F set is searched for optimal match feature points (Fₖ, fᵢ), where a distance (common distance measurement functions include a Euclidean distance, a Hamming distance, a Mahalanobis distance, and the like) between the feature points is shortest.

905: Remove a mismatched feature point according to a distance constraint D.

Two adjacent match feature point pairs (Fᵢ, fⱼ) and (Fᵢ₊₁, fⱼ₊₁) stored in the f set are traversed, to invoke respective 3D coordinates of the feature points, that is, D_Fᵢ(x, y, z), D_fⱼ(x, y, z), D_Fᵢ₊₁(x, y, z), and D_fⱼ₊₁(x, y, z). A distance d_Fᵢ between Fᵢ and Fᵢ₊₁ and a distance d_fⱼ between fⱼ and fⱼ₊₁ are calculated. If |d_fᵢ−d_fⱼ|>Th, where Th is a mismatch threshold, for example, Th=5 mm, it indicates that the match point sets (Fᵢ, fⱼ) and (Fᵢ₊₁, fⱼ₊₁) are mismatched, and the two feature point pairs are removed. Otherwise, the feature point pairs are preserved, and new match feature sets F* and f* are obtained after update.

906: Perform RANSAC consistency calculation.

RANSAC consistency is calculated in remaining F*s and f*s, and a homography matrix H is obtained. A re-projection error of a feature point set is calculated by using Formula 1.5, so as to obtain err.

907: Determine an identifier and coordinates of a touch-controllable device.

If err<T, where T is a re-projection error threshold, it indicates that a currently extracted feature point f* successfully matches a feature F* of a target in the hardware visual feature database. The identifier C of the current touch-controllable device is returned, and the image coordinates at which the target is located is calculated according to the homography matrix H. Otherwise, an operation corresponding to a next target C+1 is to be performed, and step 903 to step 907 are repeated, until all hardware is traversed.

After identifying the identifier of each touch-controllable device in the video image, the control center device 310 may send the video image and the identifier of each touch-controllable device to the remote device 330. The remote device 330 may be a device with a display interface, such as a mobile phone, a tablet computer, or a computer. The remote device 330 may display the video image on the display interface, and may display the corresponding identifier of each touch-controllable device. In this way, a user can conveniently identify, from the video image displayed on the display interface of the remote device 330, the touch-controllable device and the identifier of the touch-controllable device.

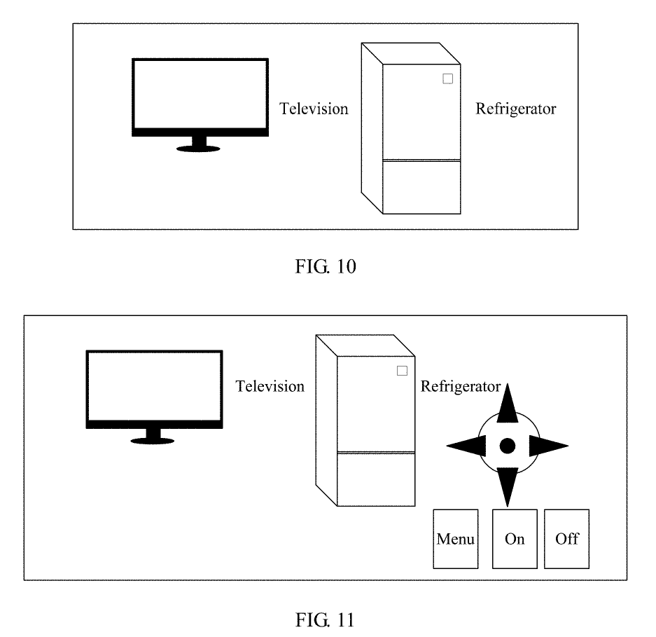

FIG. 10 is a schematic diagram of displaying a video image and a touch-controllable device on a display interface of a remote device.

When a user expects to adjust an adjustable running parameter of a touch-controllable device in the video image, the user may select the to-be-adjusted first touch-controllable device by using first input. The first input may be touch input, or may be input implemented by using another input device (for example, a mouse or a keyboard). After the user selects the first touch-controllable device, the display interface may present a control UI of the first touch-controllable device. The user may directly adjust the corresponding running parameter by using the control UI of the first touch-controllable device displayed on the display interface. The control center device 310 may receive first adjustment information sent by the remote device 330, where the first adjustment information is used to adjust a running status parameter of the first touch-controllable device. It can be understood that the first touch-controllable device is any touch-controllable device in the video image. The control center device 310 may send the first adjustment information to the first touch-controllable device. The first touch-controllable device may adjust the corresponding running status parameter according to the first adjustment information.

For example, it is assumed that touch-controllable devices in the video image include a refrigerator and a television. If the user expects to adjust an adjustable running status parameter of the refrigerator in the video image, the user may directly select an area in which the refrigerator in the video image is located. In this case, the display interface may present a control UI used for controlling the adjustable running status parameter of the refrigerator. The user may adjust the adjustable running status parameter of the refrigerator by adjusting a related parameter in the control UI.

Optionally, in another example, the control UI of the touch-controllable device may alternatively be directly superposed on a video interface. In this case, the control center device 310 may further determine coordinates of the selected to-be-adjusted first touch-controllable device, and send the coordinates of the first touch-controllable device to the remote device 330. In this way, when presenting the control UI of the first touch-controllable device, the remote device 330 may present the control UI of the first touch-controllable device according to the coordinates of the first touch-controllable device, for example, may superpose the control UI of the first touch-controllable device near the coordinates of the first touch-controllable device. Optionally, in another example, a video interface displayed by the remote device 330 may present only the selected first touch-controllable device and the control UI of the first touch-controllable device.

FIG. 11 is a schematic diagram of displaying a video image, a selected touch-controllable device, and a UI of the selected touch-controllable device on a display interface of a remote device. FIG. 11 is a schematic diagram of directly superposing the control UI on a video interface.

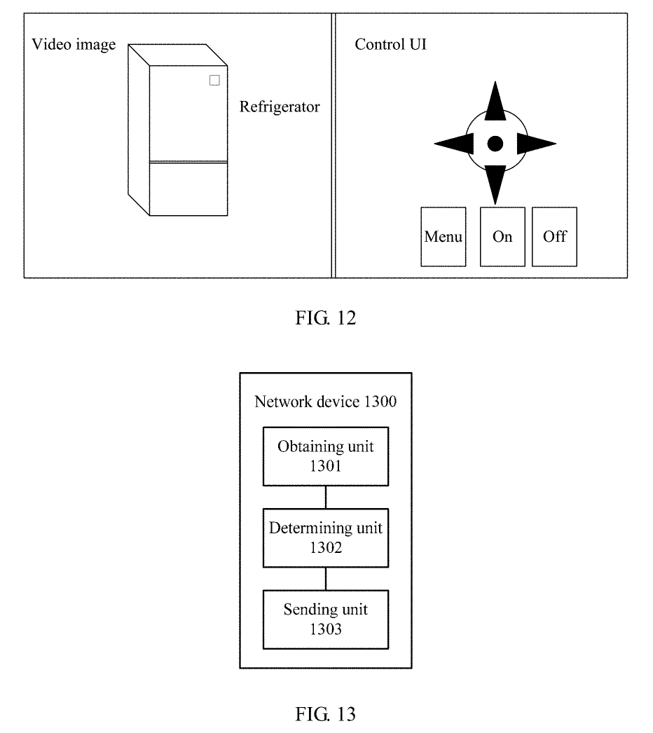

FIG. 12 is another schematic diagram of displaying a video image, a selected touch-controllable device, and a UI of the selected touch-controllable device on a display interface of a remote device. FIG. 12 is a schematic diagram of presenting only the first touch-controllable device and the control UI of the first touch-controllable device on the video interface displayed by the remote device 330.

It can be learned that, after the user selects the first touch-controllable device in the video image, the remote device 330 may present only the selected first touch-controllable device and the control UI of the first touch-controllable device on the display interface. Specifically, after the user selects one touch-controllable device in the video image, the control center device 310 may further segment the video image, and send a video image obtained by means of segmentation to the remote device 330. The video image obtained by means of segmentation may include only the first touch-controllable device selected by the user and the control UI of the first touch-controllable device. In this way, the user can view, more conveniently, the touch-controllable device that needs to be adjusted. In addition, because the video image obtained by means of segmentation includes only the to-be-adjusted first touch-controllable device, only a video of the first touch-controllable device needs to be transmitted. In this case, a video transmission quantity is reduced. This can reduce a screen delay and improve real-time performance of video image transmission.

FIG. 13 is a structural block diagram of a network device according to an example of the present disclosure. As shown in FIG. 13, the network device 1300 includes an obtaining unit 1301, a determining unit 1302, and a sending unit 1303.

The obtaining unit 1301 is configured to obtain a video image.

The determining unit 1302 is configured to determine an identifier of each of at least one touch-controllable device in the video image.

The sending unit 1303 is configured to send the video image and the identifier of each touch-controllable device to a remote device, so that a user can control the touch-controllable device in the video image by using the remote device.

The network device 1300 shown in FIG. 13 is a control center device in a remote control system. The network device 1300 shown in FIG. 13 can obtain the video image, identify the touch-controllable device in the video image, and send the video image and the identifier of the identified touch-controllable device to the remote device. In this way, the user can view, in real time, the video image by using the remote device, and can conveniently determine, from the video image according to the identifier of the touch-controllable device, a touch-controllable device that can be remotely controlled, and further select a touch-controllable device that needs to be controlled. When the user needs to adjust an adjustable running parameter of the touch-controllable device, the user can view an actual running parameter of the controlled touch-controllable device instead of a running parameter, obtained by means of simulation by using a graphical interface, of the touch controllable device.

Optionally, in an example, the determining unit 1302 is specifically configured to: perform local-feature extraction on the video image; match an extracted local feature with a visual feature of a touch-controllable device stored in a hardware database, to determine whether a visual feature, matching the local feature, of a touch-controllable device exists in the hardware database; and if the visual feature, matching the local feature, of the touch-controllable device exists in the hardware database, determine an identifier of the touch-controllable device that is included in the video image and that is corresponding to the matched visual feature. The hardware database includes attribute information of N touch-controllable devices, where the attribute information includes identifiers of the touch-controllable devices, visual features of the touch-controllable devices, hardware application programming interfaces APIs of the touch-controllable devices, and control user interfaces UIs of the touch-controllable devices.

Further, the obtaining unit 1301 is further configured to obtain the attribute information of the N touch-controllable devices. The determining unit 1302 is further configured to store the attribute information of the N touch-controllable devices in the hardware database.

Optionally, in an example, the obtaining unit 1301 is specifically configured to receive attribute information sent by each of the N touch-controllable devices. Optionally, in another example, the obtaining unit 1301 is specifically configured to receive an identifier sent by each of the N touch-controllable devices, and obtain, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

Optionally, in another example, the obtaining unit 1301 is specifically configured to receive the identifier of each touch-controllable device sent by a video capture device.

Further, the obtaining unit 1301 is further configured to receive first adjustment information sent by the remote device, where the first adjustment information is used to adjust an adjustable running parameter of a first touch-controllable device, and the at least one touch-controllable device includes the first touch-controllable device. The sending unit 1303 is further configured to send the first adjustment information to the first touch-controllable device, so that the first touch-controllable device adjusts the adjustable running parameter according to the first adjustment information.

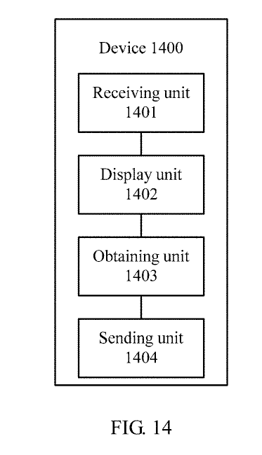

FIG. 14 is a structural block diagram of a device for controlling a touch-controllable device according to an example of the present disclosure. As shown in FIG. 14, the device 1400 includes a receiving unit 1401 and a display unit 1402.

The receiving unit 1401 is configured to receive a video image and an identifier of each touch-controllable device that are sent by a control center device.

The display unit 1402 is configured to present the video image and the identifier of each touch-controllable device on a display interface.

The device 1400 is a remote device in a system for controlling a touch-controllable device. According to the device 1400 shown in FIG. 14, a user can conveniently view the touch-controllable device on the display interface of the device.

Further, the device 1400 further includes an obtaining unit 1403. The obtaining unit 1403 is configured to obtain first input, where the first input is used to select a first touch-controllable device, and the first touch-controllable device is a touch-controllable device in the video image. The obtaining unit 1403 is further configured to obtain a control UI of the first touch-controllable device and an API of the first touch-controllable device. The display unit 1402 is further configured to display the control UI of the first touch-controllable device on the display interface.

Further, the obtaining unit 1403 is further configured to obtain second input that is used to adjust an adjustable running parameter of the first touch-controllable device. The device 1400 further includes a sending unit 1404. The sending unit 1404 is configured to send first adjustment information to the control center, where the first adjustment information is used to adjust the adjustable running parameter of the first touch-controllable device.

Examples of the present disclosure provide a visual remote control method and system for a touch-controllable device, and a related device, so that a user can conveniently determine and control, from a video image, a touch-controllable device that can be remotely controlled.

According to a first aspect, an example of the present disclosure provides a visual remote control method for a touch-controllable device, where the method is executed by a control center device in a remote control system, and the method includes: obtaining, by the control center device, a video image; determining, by the control center device, an identifier of each of at least one touch-controllable device in the video image; and sending, by the control center device, the video image and the identifier of each touch-controllable device to a remote device, so that a user can control the touch-controllable device in the video image by using the remote device.

With reference to the first aspect, in a first possible implementation, the determining, by the control center device, an identifier of each of at least one touch-controllable device in the video image includes: performing, by the control center device, local-feature extraction on the video image; matching an extracted local feature with a visual feature of a touch-controllable device stored in a hardware database, to determine whether a visual feature, matching the local feature, of a touch-controllable device exists in the hardware database; and if the visual feature, matching the local feature, of the touch-controllable device exists in the hardware database, determining an identifier of the touch-controllable device that is included in the video image and that is corresponding to the matched visual feature.

With reference to the first possible implementation, in a second possible implementation, the hardware database includes attribute information of N touch-controllable devices, where the attribute information includes identifiers of the touch-controllable devices, visual features of the touch-controllable devices, hardware application programming interfaces APIs of the touch-controllable devices, and control user interfaces UIs of the touch-controllable devices.

With reference to the second possible implementation, in a third possible implementation, before the determining, by the control center device, an identifier of each of at least one touch-controllable device in the video image, the method further includes: obtaining, by the control center device, the attribute information of the N touch-controllable devices; and storing, by the control center device, the attribute information of the N touch-controllable devices in the hardware database.

With reference to the third possible implementation, in a fourth possible implementation, the obtaining, by the control center device, the attribute information of the N touch-controllable devices includes: receiving, by the control center device, attribute information sent by each of the N touch-controllable devices; or receiving, by the control center device, an identifier sent by each of the N touch-controllable devices, and obtaining, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

With reference to the first aspect, in a fifth possible implementation, the determining, by the control center device, an identifier of each of at least one touch-controllable device in the video image includes: receiving, by the control center device, the identifier of each touch-controllable device sent by a video capture device.

With reference to any one of the first aspect or the foregoing possible implementations, in a sixth possible implementation, the method further includes: receiving, by the control center device, first adjustment information sent by the remote device, where the first adjustment information is used to adjust an adjustable running parameter of a first touch-controllable device, and the at least one touch-controllable device includes the first touch-controllable device; and sending, by the control center device, the first adjustment information to the first touch-controllable device, so that the first touch-controllable device adjusts the adjustable running parameter according to the first adjustment information.

According to a second aspect, an example of the present disclosure provides a visual remote control system for a touch-controllable device, where the system includes a control center device, a remote device, and N touch-controllable devices, where N is a positive integer greater than or equal to 1; the control center device is configured to obtain a video image; the control center device is further configured to determine an identifier of each touch-controllable device that is in the video image and that is in the N touch-controllable devices; the control center device is further configured to send the video image and the identifier of each touch-controllable device to the remote device; the remote device is configured to receive the video image and the identifier of each touch-controllable device that are sent by the control center device; and the remote device is further configured to present the video image and the identifier of each touch-controllable device on a display interface.

With reference to the second aspect, in a first possible implementation of the second aspect, the control center device is specifically configured to: perform local-feature extraction on the video image; match an extracted local feature with a visual feature of a touch-controllable device stored in a hardware database, to determine whether a visual feature, matching the local feature, of a touch-controllable device exists in the hardware database; and if the visual feature, matching the local feature, of the touch-controllable device exists in the hardware database, determine an identifier of the touch-controllable device that is included in the video image and that is corresponding to the matched visual feature.

With reference to the first possible implementation of the second aspect, in a second possible implementation of the second aspect, the hardware database includes attribute information of the N touch-controllable devices, where the attribute information includes identifiers of the touch-controllable devices, visual features of the touch-controllable devices, hardware application programming interfaces APIs of the touch-controllable devices, and control user interfaces UIs of the touch-controllable devices.

With reference to the second possible implementation of the second aspect, in a third possible implementation of the second aspect, the control center device is further configured to obtain the attribute information of the N touch-controllable devices, and store the attribute information of the N touch-controllable devices in the hardware database.

With reference to the third possible implementation of the second aspect, in a fourth possible implementation of the second aspect, the control center device is specifically configured to receive attribute information sent by each of the N touch-controllable devices; or the control center device is specifically configured to receive an identifier sent by each of the N touch-controllable devices, and obtain, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

With reference to the second aspect, in a fifth possible implementation of the second aspect, the system further includes a video capture device, where the video capture device is configured to obtain the video image, and determine the identifier of each touch-controllable device in the video image; the video capture device is further configured to send the video image and the identifier of each touch-controllable device to the control center device; and the control center device specifically receives the video image and the identifier of each touch-controllable device that are sent by the video capture device.

With reference to any one of the second aspect or the foregoing possible implementations of the second aspect, in a sixth possible implementation of the second aspect, the remote device is further configured to obtain first input, where the first input is used to select a first touch-controllable device, and the first touch-controllable device is a touch-controllable device in the video image; the remote device is further configured to obtain a control UI of the first touch-controllable device and an API of the first touch-controllable device; and the remote device is further configured to display the control UI of the first touch-controllable device on the display interface.

With reference to the sixth possible implementation of the second aspect, in a seventh possible implementation of the second aspect, the remote device is further configured to obtain second input that is used to adjust an adjustable running parameter of the first touch-controllable device, and send first adjustment information to the control center, where the first adjustment information is used to adjust the adjustable running parameter of the first touch-controllable device; the control center device is further configured to send the received first adjustment information to the first touch-controllable device; and the first touch-controllable device is further configured to adjust the corresponding adjustable running parameter according to the first adjustment information.

According to a third aspect, an example of the present disclosure provides a network device, where the device includes: an obtaining unit, configured to obtain a video image; a determining unit, configured to determine an identifier of each of at least one touch-controllable device in the video image; and a sending unit, configured to send the video image and the identifier of each touch-controllable device to a remote device, so that a user can control the touch-controllable device in the video image by using the remote device.

With reference to the third aspect, in a first possible implementation of the third aspect, the determining unit is specifically configured to: perform local-feature extraction on the video image; match an extracted local feature with a visual feature of a touch-controllable device stored in a hardware database, to determine whether a visual feature, matching the local feature, of a touch-controllable device exists in the hardware database; and if the visual feature, matching the local feature, of the touch-controllable device exists in the hardware database, determine an identifier of the touch-controllable device that is included in the video image and that is corresponding to the matched visual feature.

With reference to the first possible implementation of the third aspect, in a second possible implementation of the third aspect, the hardware database includes attribute information of N touch-controllable devices, where the attribute information includes identifiers of the touch-controllable devices, visual features of the touch-controllable devices, hardware application programming interfaces APIs of the touch-controllable devices, and control user interfaces UIs of the touch-controllable devices.

With reference to the second possible implementation of the third aspect, in a third possible implementation of the third aspect, the obtaining unit is further configured to obtain the attribute information of the N touch-controllable devices; and the determining unit is further configured to store the attribute information of the N touch-controllable devices in the hardware database.

With reference to the third possible implementation of the third aspect, in a fourth possible implementation of the third aspect, the obtaining unit is specifically configured to receive attribute information sent by each of the N touch-controllable devices; or the obtaining unit is specifically configured to receive an identifier sent by each of the N touch-controllable devices, and obtain, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

With reference to the third aspect, in a fifth possible implementation of the third aspect, the obtaining unit is specifically configured to receive the identifier of each touch-controllable device sent by a video capture device.

With reference to any one of the third aspect or the foregoing possible implementations of the third aspect, in a sixth possible implementation of the third aspect, the obtaining unit is further configured to receive first adjustment information sent by the remote device, where the first adjustment information is used to adjust an adjustable running parameter of a first touch-controllable device, and the at least one touch-controllable device includes the first touch-controllable device; and the sending unit is further configured to send the first adjustment information to the first touch-controllable device, so that the first touch-controllable device adjusts the adjustable running parameter according to the first adjustment information.

According to a fourth aspect, an example of the present disclosure provides a device for controlling a touch-controllable device, where the device includes: a receiving unit, configured to receive a video image and an identifier of each touch-controllable device that are sent by a control center device; and a display unit, configured to present the video image and the identifier of each touch-controllable device on a display interface.

With reference to the fourth aspect, in a first possible implementation of the fourth aspect, the device further includes an obtaining unit, where the obtaining unit is configured to obtain first input, where the first input is used to select a first touch-controllable device, and the first touch-controllable device is a touch-controllable device in the video image; the obtaining unit is further configured to obtain a control UI of the first touch-controllable device and an API of the first touch-controllable device; and the display unit is further configured to display the control UI of the first touch-controllable device on the display interface.

With reference to the first possible implementation of the fourth aspect, in a second possible implementation of the fourth aspect, the obtaining unit is further configured to obtain second input that is used to adjust an adjustable running parameter of the first touch-controllable device; and the device further includes a sending unit, where the sending unit is configured to send first adjustment information to the control center, and the first adjustment information is used to adjust the adjustable running parameter of the first touch-controllable device.

In the foregoing technical solutions, the control center device in the remote control system can obtain the video image, identify the touch-controllable device in the video image, and send the video image and the identifier of the identified touch-controllable device to the remote device. In this way, the user can view, in real time, the video image by using the remote device, and can conveniently determine, from the video image according to the identifier of the touch-controllable device, a touch-controllable device that can be remotely controlled, and further select a touch-controllable device that needs to be controlled. When the user needs to adjust an adjustable running parameter of the touch-controllable device, the user can view an actual running parameter of the controlled touch-controllable device instead of a running parameter, obtained by means of simulation by using a graphical interface, of the touch controllable device.

A person of ordinary skill in the art may be aware that units and algorithm steps in examples described with reference to the examples disclosed in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that such an implementation goes beyond the scope of the present disclosure.

It can be clearly understood by a person skilled in the art that, for ease and brevity of description, for detailed working processes of the foregoing systems, apparatuses, and units, reference may be made to corresponding processes in the foregoing method examples, and details are not described herein again.

In the several examples provided in this application, it should be understood that the disclosed systems, apparatuses, and methods may be implemented in other manners. For example, the described apparatus example is merely an example. For example, the unit division is merely logical function division and may be other division in actual implementation. For example, multiple units or components may be combined or may be integrated into another system, or some features may be ignored or not performed. In addition, the displayed or discussed mutual couplings, direct couplings, or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on multiple network units. Some or all of the units may be selected according to an actual requirement, to achieve the objectives of the solutions in the examples.

In addition, functional units in the examples of the present disclosure may be integrated into one processing unit, or each of the units may exist alone physically, or two or more units may be integrated into one unit.

When the functions are implemented in a form of a software function unit, and are sold or used as an independent product, the functions may be stored in a computer readable storage medium. Based on such an understanding, the technical solutions of the present disclosure, or some of the technical solutions may be implemented in a form of a software product. The computer software product is stored in a storage medium, and includes several instructions for instructing a computer device (which may be a personal computer, a server, a network device, or the like) or a processor (processor) to perform all or some of the steps of the methods described in the examples of the present disclosure. The foregoing storage medium includes any medium that can store program code, such as a USB flash drive, a removable hard disk, a read-only memory (ROM, Read-Only Memory), a random access memory (RAM, Random Access Memory), a magnetic disk, or an optical disc.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors.

The foregoing descriptions are merely some implementations of the present disclosure, but are not intended to limit the protection scope of the present disclosure. Any variation or replacement readily figured out by a person skilled in the art within the technical scope disclosed in the present disclosure shall fall within the protection scope of the present disclosure.

What is claimed is:

1. A visual remote control method for controlling a touch-controllable device, wherein the method is executed by a control center device in a remote control system, and the method comprises:
obtaining, by the control center device, a video image;
determining, by the control center device, an identifier of each of at least one touch-controllable device in the video image; and
sending, by the control center device, the video image and the identifier of each touch-controllable device to a remote device, so that the touch-controllable device in the video image is controllable by using the remote device.

2. The method according to claim 1, wherein determining, by the control center device, the identifier of each of at least one touch-controllable device in the video image comprises:
performing, by the control center device, local-feature extraction on the video image;
matching an extracted local feature with a visual feature of the touch-controllable device stored in a hardware database, and determining whether the visual feature of the touch-controllable device that matches the local feature exists in the hardware database; and
when the visual feature of the touch-controllable device that matches the local feature exists in the hardware database, determining the identifier of the touch-controllable device that is comprised in the video image is corresponding to the matched visual feature.

3. The method according to claim 2, wherein the hardware database comprises attribute information of N touch-controllable devices and N is a positive integer that is greater than or equal to 1, wherein the attribute information comprises identifiers of the touch-controllable devices, visual features of the touch-controllable devices, hardware application programming interfaces (APIs) of the touch-controllable devices, and control user interfaces (UIs) of the touch-controllable devices.

4. The method according to claim 3, wherein, before determining, by the control center device, the identifier of each of at least one touch-controllable device in the video image, the method further comprises:
obtaining, by the control center device, the attribute information of the N touch-controllable devices; and
storing, by the control center device, the attribute information of the N touch-controllable devices in the hardware database.

5. The method according to claim 4, wherein obtaining, by the control center device, the attribute information of the N touch-controllable devices comprises:
receiving, by the control center device, the attribute information sent by each of the N touch-controllable devices; or
receiving, by the control center device, the identifier sent by each of the N touch-controllable devices, and obtaining, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

6. The method according to claim 1, wherein determining, by the control center device, the identifier of each of at least one touch-controllable device in the video image comprises:
receiving, by the control center device, the identifier of each touch-controllable device sent by a video capture device.

7. The method according to claim 1, wherein the method further comprises:
receiving, by the control center device, first adjustment information sent by the remote device, wherein the first adjustment information is used to adjust an adjustable running parameter of a first touch-controllable device, and the at least one touch-controllable device comprises the first touch-controllable device; and
sending, by the control center device, the first adjustment information to the first touch-controllable device, so that the first touch-controllable device adjusts the adjustable running parameter according to the first adjustment information.

8. A visual remote control system for controlling a touch-controllable device, wherein the system comprises a control center device, a remote device, and N touch-controllable devices, wherein:
N is a positive integer that is greater than or equal to 1;
the control center device is configured to obtain a video image;
the control center device is further configured to determine an identifier of each touch-controllable device that is in the video image and each touch-controllable device is in the N touch-controllable devices;
the control center device is further configured to send the video image and the identifier of each touch-controllable device to the remote device;
the remote device is configured to receive the video image and the identifier of each touch-controllable device that are sent by the control center device; and
the remote device is further configured to present the video image and the identifier of each touch-controllable device on a display interface.

9. The system according to claim 8, wherein the control center device is configured to: perform local-feature extraction on the video image; match an extracted local feature with a visual feature of the touch-controllable device stored in a hardware database to determine whether the visual feature of the touch-controllable device that matches the local feature exists in the hardware database; and when the visual feature of the touch-controllable device that matches the local feature exists in the hardware database, determine the identifier of the touch-controllable device that is comprised in the video image is corresponding to the matched visual feature.

10. The system according to claim 9, wherein the hardware database comprises attribute information of the N touch-controllable devices, wherein the attribute information comprises identifiers of the touch-controllable devices, visual features of the touch-controllable devices, hardware application programming interfaces (APIs) of the touch-controllable devices, and control user interfaces (UIs) of the touch-controllable devices.

11. The system according to claim 10, wherein the control center device is further configured to obtain the attribute information of the N touch-controllable devices, and store the attribute information of the N touch-controllable devices in the hardware database.

12. The system according to claim 11, wherein:
the control center device is configured to receive the attribute information sent by each of the N touch-controllable devices; or
the control center device is configured to receive the identifier sent by each of the N touch-controllable devices, and obtain, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

13. The system according to claim 8, wherein the system further comprises a video capture device, wherein:
the video capture device is configured to obtain the video image, and determine the identifier of each touch-controllable device in the video image;
the video capture device is further configured to send the video image and the identifier of each touch-controllable device to the control center device; and
the control center device receives the video image and the identifier of each touch-controllable device that are sent by the video capture device.

14. The system according to claim 8, wherein the remote device is further configured to obtain first input, wherein the first input is used to select a first touch-controllable device, and the touch-controllable device in the video image comprise the first touch-controllable device;
the remote device is further configured to obtain a control UI of the first touch-controllable device and an API of the first touch-controllable device; and
the remote device is further configured to display the control UI of the first touch-controllable device on the display interface.

15. The system according to claim 14, wherein the remote device is further configured to obtain second input that is used to adjust an adjustable running parameter of the first touch-controllable device, and send first adjustment information to the control center device, wherein the first adjustment information is used to adjust the adjustable running parameter of the first touch-controllable device;
the control center device is further configured to send the received first adjustment information to the first touch-controllable device; and
the first touch-controllable device is configured to adjust the corresponding adjustable running parameter according to the first adjustment information.

16. A network device for controlling a touch-controllable device, comprising:
an obtaining circuit, configured to obtain a video image;
a determining circuit, configured to determine an identifier of each of at least one touch-controllable device in the video image; and
a sending circuit, configured to send the video image and the identifier of each touch-controllable device to a remote device, so that the touch-controllable device in the video image is controllable by using the remote device.

17. The network device according to claim 16, wherein the determining circuit is configured to: perform local-feature extraction on the video image; match an extracted local feature with a visual feature of a touch-controllable device stored in a hardware database to determine whether a visual feature of a touch-controllable device that matches the local feature exists in the hardware database; and when the visual feature of the touch-controllable device that matches the local feature exists in the hardware database, determine the identifier of the touch-controllable device that is comprised in the video image is corresponding to the matched visual feature.

18. The network device according to claim 17, wherein the hardware database comprises attribute information of N touch-controllable devices, wherein the attribute information comprises identifiers of the touch-controllable devices, visual features of the touch-controllable devices, hardware application programming interfaces (APIs) of the touch-controllable devices, and control user interfaces (UIs) of the touch-controllable devices.

19. The network device according to claim 18, wherein:
the obtaining circuit is further configured to obtain the attribute information of the N touch-controllable devices; and
the determining circuit is further configured to store the attribute information of the N touch-controllable devices in the hardware database.

20. The network device according to claim 19, wherein:
the obtaining circuit is configured to receive the attribute information sent by each of the N touch-controllable devices; or
the obtaining circuit is configured to receive the identifier sent by each of the N touch-controllable devices, and obtain, according to the identifiers of the N touch-controllable devices, the visual features of the N touch-controllable devices, the APIs of the N touch-controllable devices, and the control UIs of the N touch-controllable devices from a server that stores the attribute information of the N touch-controllable devices.

21. The network device according to claim 16, wherein the obtaining circuit is configured to receive the identifier of each touch-controllable device sent by a video capture device.

22. The network device according to claim 16, wherein the obtaining circuit is further configured to receive first adjustment information sent by the remote device, wherein the first adjustment information is used to adjust an adjustable running parameter of a first touch-controllable device, and the at least one touch-controllable device comprises the first touch-controllable device; and
the sending circuit is further configured to send the first adjustment information to the first touch-controllable device, so that the first touch-controllable device adjusts the adjustable running parameter according to the first adjustment information.

23. A device for controlling a touch-controllable device, wherein the device comprises:
a receiving circuit, configured to receive a video image and an identifier of each touch-controllable device that are sent by a control center device; and
a display circuit, configured to present the video image and the identifier of each touch-controllable device on a display interface.

24. The device according to claim 23, wherein:
the device further comprises an obtaining circuit, wherein the obtaining circuit is configured to obtain first input, wherein the first input is used to select a first touch-controllable device, and the touch-controllable device in the video image comprises the first touch-controllable device;
the obtaining circuit is further configured to obtain a control UI of the first touch-controllable device and an API of the first touch-controllable device; and
the display circuit is further configured to display the control UI of the first touch-controllable device on the display interface.

25. The device according to claim 24, wherein:
the obtaining circuit is further configured to obtain second input that is used to adjust an adjustable running parameter of the first touch-controllable device; and
the device further comprises a sending circuit, wherein the sending circuit is configured to send first adjustment information to the control center device, and the first adjustment information is used to adjust the adjustable running parameter of the first touch-controllable device.
